(19) United States
(12) Patent Application Publication
(10) Pub. No.: US 2003/0171933 A1
(43) Pub. Date: Sep. 11, 2003

(54) METHOD AND DEVICE FOR RECORDING IN CYCLIC LOOPS SEVERAL SOUND SEQUENCES

(76) Inventor: EMMANUEL PERILLE, VILLEMOMBLE (FR)

Correspondence Address: ROBERT H RINES, 81 NORTH STATE STREET, CONCORD, NH, 03301

(21) Appl. No.: 09/242,456

(22) PCT Filed: Aug. 11, 1997
(86) PCT No.: PCT/FR97/01477

(30) Foreign Application Priority Data
Aug. 12, 1996 (FR) 9610109

(51) Int. Cl. G10L 19/00

(52) U.S. Cl. 704/500

(57) ABSTRACT

By another route, it remains possible by handling a moving cursor to reach a similar sound effect which could be compared with the wellknown ‘scratch’ obtained when manipulating the vinyl record on a turntable to act on its speed. But now indeed, with what has been previously described about the device, the sampling rate can be easily, immediately and proportionally controlled by the moving cursor speed itself. Such a moving cursor could simply be carried out with a trimmer which measured level, once affected by a mathematical signed derivation, directly gives the cursor speed which then can proportionally control the sampling rate. But the moving cursor can also be carried out with a conventional computer accessory such as the one which is usually called ‘mouse’.

The present invention relates to a method and a device for recording in cyclic loops several sound sequences, for their simultaneous reproduction, by means of a device using sampled sound signals and comprising a memory, a unit for controlling the memory and means for reproducing sounds.

The invention is specially useful for a kind of pseudo several track playback device intended for reproducing in a cyclic way according to a definite rhythmic coefficient several sampled sound signals recorded in memory as conformed to the method of the invention.

Concerning modern music, the fact that some pieces are more and more reproduced in a cyclic way has convinced some sound processing hardware manufacturers of designing some digital sound samplers made to mix in an intuitive way several sampled sound signals recorded in memory.

For instance, WO-A-95/10138 is known where it is described an audio signal processor that can at one and the same time sample and compute some audio signals. The processor can also compute some external audio signals in real time so to obtain some complex chorus and echo effects. For this, the sampled audio signal is shared between two parts so the one is individually computed from the other.

EP-A-O 551 884 which concerns a sound signal generator fit to be connected to a home computer, is also known.

EP-A-O 484 047 is known which deals with a device that produces an audio signal requiring a MIDI said sequence for the cyclic synchronization.

It is also knows U.S. Pat. No. 5,194,681 which describes a device comprising a sampling device in which the start point and the stop point of a loop have to be determined and where an interpolation is used to cancel sound blanks between the two said points when the loop is closed.

As one knows, a simple solution to obtain a cyclic musical background is to reproduce in an everlasting repeating way one or several sound sequences all stuck in a same beat. This is what a device can make, reproducing several sound sequences read from a memory. In most of the cases, these sound signals have been sampled and digitalized before to be written in a memory.

Such a reproduction is not specially a technical problem for the Man of the Art, as it is just to read one or several memories and to mix their contents in an analogic or digital way depending on the technology. Nevertheless, this requires most of the time the use of MIDI type triggering sequences that are to be synchronized. Furthermore, when recording in memory several sound signals, such as signals coming out from records for instance, these musical sound signals are often based upon different tempos and loops made with these signals are not always equal in term of duration, and so on, so their global playback mix is quite a serious problem in term of synchronization. The user has to refine by himself the start point and the end point of each recorded sequence, discard undesirable parts, adjust the loops length, change the tempo of one loop, and so on . . . But some electronic devices help the user for this, but only after having recorded signals. This is why such devices remain quite complex, and thus expensive, as the ones on the market at the present time, such as the excellent REMIX 16™ device made by AKAI™ who have designed it mostly for professional users such as “DJs” (“Disc jockeys”) who are kept busy with sounds.

Nevertheless, such a device does not always fit well with the reproduction of some recorded sound signals which beat is sometime difficult to detect with an electronic beat analysis, in the case for instance of vocal signals.

An object of the present invention is to solve these problems with a method and a device working in an everlasting way so signals require no triggering sequence to be synchronized.

Another object of the invention is to design an easy-to-use device made for some one who is not a professional user.

A third object of the invention is mainly to improve vocal signal processing.

These objects are reached with the method and the device of the invention.

On a first sight of the invention, the method is defined by the following steps:

triggering loops with default values, so that they function substantially permanently with their desired values in terms of a tempo common to all of the loops, of the desired number of measures for each of said loops and of the sampling frequency; and

recording the sound signals for at least one definite loop.

In a favorite way, the loops default values are previously defined.

In the case of the memory being a random access type memory and of the control unit including a cyclic addresses generator dedicated to each of said loops, triggering with default values the cyclic addresses generators dedicated to each of said loops, so that the said generators work permanently in a cyclic way.

In a favorite way, limiting the recording time to the strict length of the defined loop, the said length being defined in function of the tempo, the number of measures of the loop and the sampling frequency.

At another sight of the invention, the device includes a sampler, a random access memory, an operating unit of the memory including a cyclic addresses generator dedicated to each of said loops and means for reproducing sounds; the addresses generators dedicated to each of said loops working permanently in a cyclic way depending on the sampling frequency, with some given default values for the loops.

In a favorite way, the device comprises means to change the loops default values and specially to give a common tempo for all of the loops, the number of measures to each loop before recording, and the sampling frequency value.

The invention will be better understood, and its others objects, advantages and characteristics will appear much more clearly by reading the following description about a favorite example of creation that does not suggest any restrictions and at which

a board is given with the following drawings:

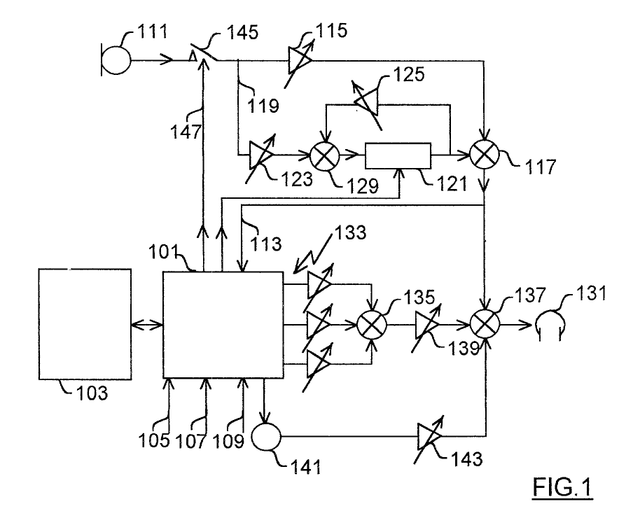

FIG. 1 is a synoptic diagram of the device according to the invention;

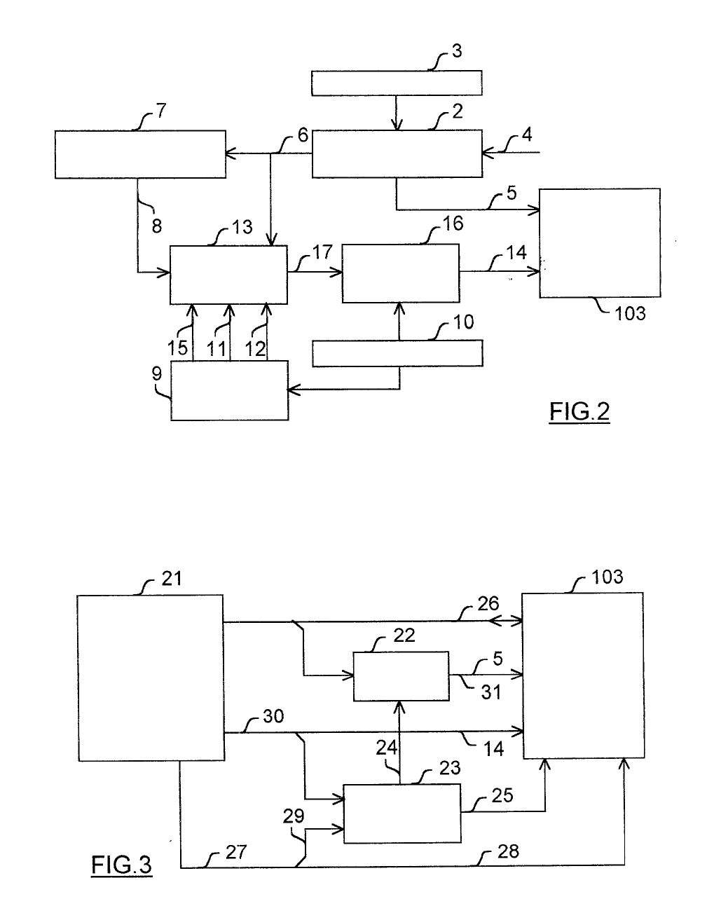

FIG. 2 diagram shows a synoptic array which represents an addresses generating device that works in page mode as suitable to be included in the device of the submitted invention; and

FIG. 3 shows a synoptic array of electric connections between a microcomputer and a random access memory which address bus is expanded (also said demultiplexed).

The following description will refer to a digital type device working with a random access memory, although another type of digital or analog device could also work with a sequential access memory.

So, FIG. 1 shows a digital type device comprising an operating unit 101 including the memory 103 operating unit, a sampler and all of the glue electronic circuits concerning the device itself. The memory 103 is a random access type memory connected to the operating unit 101 which can use it 103 to read or write data.

A “sampler” must be here understood with its conventional sense meaning a device to sample an analog sound signal, but also a digital signal processor used to be interfaced with an optical disc player or a computer. Understood with its conventional meaning, a sampler usually comprises for analog signals some anti-aliasing low-pass filters followed by an analog to digital converter. But concerning the next case, the sampler comprises a digital signal receiver and either just re-sample the input digital signal at the output sampling rate, or just convert the sampling rate in order to let for instance the device work with another sampling rate different from the input. A dual access sequential memory, usually called a first-in first-out memory (FIFO), can be included more for receiving some high speed burst mode input digital signals. Concerning the present example of creation of the invention which is illustrated here, the sampler belongs to the said conventional types, since the input sound signal comes out from a microphone.

When starting at its initial state, the operating unit 101 reads the default values to apply to the loops, meaning the common tempo, the number of measures and the sampling frequency of the sound signals. Then the cyclic addresses generators start working permanently with these given values. In a favorite way, these steps are executed as soon as the device starts working, but never later than the very moment recording starts.

In case of the given default values do not meet, the user can enter the values he wishes by using the inputs 105, 107 and 109 of the operating unit 101. Then the cyclic addresses generators permanently work with these new given values.

Dealing with the described example and in a favorite way, sound signals which are to be processed come out from a microphone 111. Although it is not clearly visible in the drawing, stereophony can easily be created by duplicating the drawing. The signal coming out from the microphone 111 goes into the input 113 of the operating unit 101 to be sampled and written in memory, by the means of an amplifier 115 to adjust the input gain.

In a favorite way, this input signal 113 can be overdubbed with a re-echoing signal by the means of an adding operator 117. In this case, the signal coming out from the microphone 111 is also more or less amplified by the amplifier 123 before being applied to 119 at the input of a well known retroactive loop that includes a delay line 121, an operative amplifier 125 and an adding operator 129. The delay line parameters are totally controlled by the operating unit 101 itself. In fact, this delay line 121 remains theorical, since the said retroactive loop can be carried out by the operating unit 101 and the memory 103 just as if it was another loop. The signal applied to the input 113 of the operating unit 101 is already affected according to the user's choice.

In this described example, the user can simultaneously monitor with headphones 131 the signal being recorded in memory.

Simultaneously with the defined loop being recorded, the operating unit 101 plays back in a cyclic way the other previously recorded loops. In order to let it clear, FIG. 1 only shows three outputs 133 each equipped with an amplifier, and all connected to an adding operator 135 to produce a global mix of them. In reality, the illustrated number of outputs is not restricted to three. The signal coming out from this adding operator 135 goes through an amplifier 139 before being applied to another adding operator 137 which also receives the output signal produced by the adding operator 117.

In a favorite way and according to the loops values, the internal clock in the operating unit gives a signal for a metronome 141 which output is connected to the adding operator 137 by the means of an amplifier 143.

By using his headphones connected to the adding operator 137 output, the user can monitor all of the signals mixed together coming out from the microphone 111 and its re-echoing effect, from the previously recorded loops 133 and from the metronome 141.

In a favorite way, means are given to the operating unit 101 for restricting the recording time to the loop length itself. By the “loop length” must be understood the number of signal samples the loop is supposed to have according to the method of the invention, but not about the sound sequence recording time itself.

Thus, as shown by the diagram, the said means are illustrated by a switch 145 which is situated at the microphone 111 output and controlled by another output 147 of the operating unit 101. But of course this switch 145 remains fictitious, since the defined loop address generator can act in a similar way once well controlled.

Thus, as due to the previously defined loops values (tempo, number of measure for each loop, sampling frequency), and due to loops keeping on “spinning” previously to recording (or eventually starting spinning at the very moment recording starts), loops remain each others synchronized without the need of any triggering sequences.

Of course, the previous recorded sequences should have to be erased from memory before starting recording the first loop. Nevertheless, this becomes optional when the user properly sets every amplifier connected to each loop recording input. By these means, as rendering void the gains of the amplifiers 123 and 125, the according loop is being erased at the rate of its addresses generator.

The input signals have been until now in this example the ones coming out from a microphone 111. But they could also come from a record player or a tape recorder, in other terms from any previously recorded sound sources, and in this case signals once recorded in loops will certainly have to be wheelslided each others to reach a better beat coincidence once correctly placed side by side. Such a wheelsiding is easy to make by controlling the given parameters when monitoring the cyclic loops.

Now, let us describe an example of an addresses generator that fits well to be included in the invention.

Concerning the illustrated example shown by FIG. 2 working with a constant sampling frequency, the device mainly comprises, according to a certain scheme, a first counter 2 modulo the rhythmic coefficient, a second binary counter 7, a memory 9 in which are stocked parameters, and a combinatorial operator 13.

The first counter 2, which programmable modulo is controlled by the rhythmic coefficient register 3, works at the rate of its clock, the audio signal sampling frequency 4, and thus produces, first, the least significant address 5 applied to the random access memory 103 and, second, a borrow information 6 for the second counter 7 which only works at the borrow information 6 rate to produce a basis address 8 applied to the combinatorial operator 13.

According to a defined sampled audio signal 10 among the recorded ones, the parameter memory 9 gives a masking vector 11 and a replacing vector 12 applied to the combinatorial operator 13. The combinatorial operator 13 produces the most significant address 14 to the random access memory 103 by selecting from the basis address 8 the bits to go through according to the masking vector 11 from the bits to be replaced by the replacing vector 12 value.

In a favorite way, parameters written in the parameter memory 9 are defined for ever in the software where loops dimensions in memory and the memory organization are definitive. Nevertheless, these parameters could change during execution by the means of a specific interface included in the software.

Thus, the programmable modulo counter 2 gives the least significant address common to every audio signal sample reproduced in a same sampling rate period 4. Furthermore, the counter 2 works in a cyclic sequence which length corresponds to the rhythmic coefficient programmed for instance in the register 3, and at each time the said cyclic sequence makes a whole revolution, the counter 2 delivers a borrow signal 6 to count up (or down) the second binary counter 7 which gives the basis address 8.

Furthermore, the parameter memory 9 gives to the combinatorial operator 13 a wheellsliding value 15 to be added to the basis address 8 before applying the previous vectors 11 and 12 to compute the most significant address of the random access memory.

This wheelsliding value is to rotary shift in terms of proportions of beat a loop in comparison with the others. This rotary shift value is quantified in terms of number of sample groups which size depends on the rhythmic coefficient, and such a quantification is quite enough to reach a correct beat accuracy. A said group is for instance around 20 msec with a 32 kHz sampling rate frequency and a rhythmic coefficient equal to 650.

Furthermore, the device comprises a memory of pointers 16 in which the combinatorial operator 13 writes the most significant address 17 when appears the borrow information 6 which comes from the first programmable modulo counter 2, the random access memory most significant address being read at each sampling rate period 4, for a defined audio signal, and from the memory of pointers 16.

The memory of pointers 16 saves the most significant address value in order to prevent from computing it again for each sampling rate period corresponding to a similar most significant address based upon an unchanged basis address 8 value as long as the borrow signal 6 remains inactive. But when this last 6 comes out, then the basis address 8 value is updated by the binary counter 7, and the combinatorial operator 13 is called to compute again every most significant address to write the values into the memory of pointers 16.

FIG. 3 shows how the invention can electrically work, according to the synoptic array of electric connections between a programmable microcomputer and a random access memory which address bus is expanded (also said demultiplexed). A microcomputer 21 is electrically connected in a conventional way to a random access memory 103, by the means of a data bus 26, an address bus 30, 31 and a control bus 27. Of course, audio signal samples are moved via the data bus 26. The most significant address 14 is applied to the memory 103 via the address bus 30 part. As usual, the control bus 27 carries out the signals to the memory 103 for read and write memory cycles during memory selection cycles.

Address expanding works by the means of a register 22 connected between the data bus 26 and the address bus other 31 part via which is applied the least significant address 5. An address selection circuit 23 receives the address bus 30 part and the control bus 27 from which it receives the memory selection signals 29. This address selection circuit 23 is meanly to give a latching signal 24 for the register 22 in order to let the microcomputer 21 write the least significant address 5 into this register 22 via the data bus 26. The same circuit 23 also gives a chip select signal 25 to the memory 103 during read and write memory cycles.

A microcomputer is here better to use than a microprocessor since it includes on-chip all of the basic components to let the program being completely on-chip executed by the microcomputer itself without the use of any glue external memories.

By this way, a microcomputer can easily execute a software that includes all of the required functions to work according to the invention. Now, let us describe briefly the main core of such a software which must not be understood as to be restricted to the following example.

It comprises two tasks, the sampling rate 4 interrupt task and the main program.

The sampling rate task mainly concerns the first counter 2 and the memory of pointers 16. At each interruption period, the first counter 2 counts one step down if it did not reach zero before, otherwise it jumps up to the rhythmic coefficient value, and a boolean variable standing for the borrow information 6 becomes true, whereas changing the state of a second boolean variable standing for the swapping state of the couple of column pointers arrays.

The memory of pointers 16, which could have been carried out with a random dual access memory in the case of a hardware solution, is in the software represented by a couple of column pointers arrays, the size of one of these arrays being the exact number of audio signals to reproduce. According to the value of the previous second boolean variable, the sampling rate task chooses one of the two said arrays. As described in the following explanations, one array is been read by the sampling rate task while the main program books the other array to write every most significant address concerning the next borrow 6 to come.

By peeping at the boolean variable state standing for the borrow 6, the main program is; kept sleeping as long as the said state remains false, and wakes up once it comes true. By switching it back to false, the main program acknowledges the call before starting computing the next most significant addresses 14 to come. For this, the main program first makes the second counter 7 counts one step up to obtain the new basis address 8 on which is computed the most significant address for each audio signal 10 to reproduce, the said address being written in the column pointers array indexed by the number of the said audio signal.

Furthermore and according to the invention, the device comprises in a favorite way a programmable manual controlling desk to adjust for each loop the mixing levels in terms of volume and eventually of stereo balance. Such a controlling desk can be equipped with only a couple of trimmers to adjust each loop levels provided that the said desk also includes a keyboard to select the parameter to adjust with the trimmers. As parameters are digitally adjusted, the said desk mainly comprises inside an analog to digital converter in order to measure the trimmer position to have it digitally processed with the sound signal. To avoid adjustment breaks, the previously recorded value of the parameter to adjust will be kept compared with the measured trimmer position until equality to start sticking the said value at the measured trimmer position.

Although the submitted invention has been here represented and described with its most nowadays favorite examples of creation, is well admitted that the skilled man can still make of it some diversities and modifications without escaping from the following claims that characterize the submitted invention.

More particularly, with some already digitalized input sound signals such as the ones coming out from a computer, a hard disc or an optical disc player, the device furthermore comprises means to place loops side by side. For this and in the following example, a direct access memory processor (DMA) will help to transfer data through the buffer set between the disc and the memory without stopping the loops addressing. As it has been described before, the page mode addressing concerning the loops allows it, since page mode addressing processes quickly enough in comparison with the sampling rate period to let the DMA processor reach its buffer. To reach again the correct wheelslided position, it is just to link a basis address with the sound content of the loop to load.

1- Method for recording in cyclic loops several sound sequences, for them simultaneous reproduction, by means of a device using sampled sound signals and comprising a memory, a unit for controlling the memory and means for reproducing sounds, characterized by the following steps:
triggering loops with default values, so that they function substantially permanently with their desired values in terms of a tempo common to all of the loops, of the desired number of measures for each of said loops and of the sampling frequency; and
recording the sound signals for at least one definite loop.

2- Method according to claim 1 characterized by the fact that the default values of the said loops are previously defined.

3- Method according to claims 1 or 2 characterized by the fact that the said memory being a random access type memory and the said control unit including a cyclic addresses generator dedicated to each of the loops, triggering with default values the cyclic addresses generators dedicated to each of the loops, so that the said generators work permanently in a cyclic way.

4- Method according to one of the previous claims from 1 to 3, characterized by limiting the recording time to the strict length of the defined loop, the said length being defined in function of the tempo, the number of measures of the said loop and the sampling frequency.

5- Method according to one of the previous claims from 1 to 4, characterized by the fact that loops are wheelslided to be placed side by side each others to reach a better beat coincidence.

6- Device to work as the method according to one of the claims from 3 to 5, the said device using sampled sound signals including a random access memory (103), an operating unit (101) of the memory including a cyclic addresses generator dedicated to each of the loops and means for reproducing sounds, characterized by the fact that the said addresses generators dedicated to each of said loops work permanently in a cyclic way depending on the sampling frequency, never later than the very moment the said recording starts, with some given default values for the loops.

7- Device according to claim 6, characterized by the fact that it comprises means to change the said default values of the loops, and specially to give a common tempo for all of the loops, the number of measures to each loop before recording, and the sampling frequency value.

8- Device according to claims 6 or 7, characterized by the fact that it furthermore comprises a cyclic sequence addresses common generator working at the rate of the sampling frequency and controlling the said addresses generators dedicated to each loop, the memory being successively addressed with the both linked and side by side placed addresses, meaning the one given by the said dedicated generator, and the one given by the said common generator.

9- Device according to claim 8 characterized by the fact that it furthermore comprises a memory for addresses, in which are successively written the addresses dedicated to samples of concerned loops, the random access memory being thus addressed with the content read from the said memory for addresses, as long as the said common generator has not reached yet its whole revolution.

10- Device according to one of the previous claims from 6 to 9, characterized by the fact that it furthermore comprises means to place loops side by side specially when the input sound signals are already digitalized.

11- Device according to one of the previous claims from 6 to 10, characterized by the fact that it furthermore comprises means for restricting the said recording time to the recorded loop length itself.

12- Device according to one of the previous claims from 6 to 11, characterized by the fact that it comprises a metronome working on the same tempo.

13- Device according to one of the previous claims from 6 to 11, characterized by the fact that it comprises a manual controlling desk to adjust for each loop to reproduce the mixing levels in terms of volume and stereo balance, and, furthermore, eventually to adjust in the same terms the mixing levels of every loop simultaneously.

14- Device according to claim 13, characterized by the fact that it furthermore comprises a moving cursor which speed proportionally controls in real time the sampling rate frequency.
